(19) United States
(12) Patent Application Publication
(10) Pub. No.: US 2022/0377644 A1
(43) Pub. Date: Nov. 24, 2022

(54) RADIO COMMUNICATION APPARATUS, RADIO COMMUNICATION METHOD, AND RADIO COMMUNICATION SYSTEM

(71) Applicant: Panasonic Intellectual Property Management Co., Ltd., Osaka (JP)

(72) Inventors: Yohei MORISHITA, Kanagawa (JP); Naganori SHIRAKATA, Kanagawa (JP); Toshihiro TERAOKA, Kanagawa (JP); Tomohiro MURATA, Kanagawa (JP)

(21) Appl. No.: 17/883,293

(22) Filed: Aug. 8, 2022

Related U.S. Application Data
(63) Continuation of application No. PCT/JP2020/043407, filed on Nov. 20, 2020.

(30) Foreign Application Priority Data
Feb. 10, 2020 (JP) 2020-020579

(51) Int. Cl. H04W 40/22; H04W 40/12; H04W 40/20

(52) U.S. Cl. CPC H04W 40/22; H04W 40/12; H04W 40/20

(57) ABSTRACT

A radio communication apparatus includes reception circuitry, which, in operation, receives a first frame transmitted by a first node in a wireless mesh network; and control circuitry, which, in operation, configures a relay destination node as second information in case that the first frame includes first information indicating a third node that performs transmission in cooperation with a second node that transmits a radio signal to a radio link in which communication quality is less than a threshold in the wireless mesh network and in case that the third node included in the first information indicates the radio communication apparatus, the relay destination node being a node to which the second node transmits the first frame, the second information indicating a relay destination node to which the third node transmits the first frame.

### TECHNICAL FIELD

The present disclosure relates to a radio communication apparatus, a radio communication method, and a radio communication system.

### BACKGROUND ART

Various studies have been made on a “wireless mesh network” which is a radio network formed in the form of a network by a plurality of radio communication apparatuses (also referred to as nodes, radio nodes, radio devices, or radio communication terminals) communicating with one another (e.g., see Patent Literature (hereinafter, referred to as “PTL” 1).

### CITATION LIST

### Patent Literature

### PTL 1

Japanese Unexamined Patent Application Publication (Translation of PCT Application) No. 2008-541603

### SUMMARY OF INVENTION

However, there is scope for further study on a method for improving throughput in a wireless mesh network.

One non-limiting and exemplary embodiment of the present disclosure facilitates providing a radio communication apparatus, a radio communication method, and a radio communication system capable of improving throughput in a wireless mesh network.

A radio communication apparatus according to one exemplary embodiment of the present disclosure is a radio communication apparatus including: reception circuitry, which, in operation, receives a first frame transmitted by a first node in a wireless mesh network; and control circuitry, which, in operation, configures a relay destination node as second information in case that the first frame includes first information indicating a third node that performs transmission in cooperation with a second node that transmits a radio signal to a radio link in which communication quality is less than a threshold in the wireless mesh network and in case that the third node included in the first information indicates the radio communication apparatus, the relay destination node being a node to which the second node transmits the first frame, the second information indicating a relay destination node to which the third node transmits the first frame.

Note that these generic or specific aspects may be achieved by a system, an apparatus, a method, an integrated circuit, a computer program, or a recoding medium, and also by any combination of the system, the apparatus, the method, the integrated circuit, the computer program, and the recoding medium.

According to one exemplary embodiment of the present disclosure, throughput in a wireless mesh network can be improved.

Additional benefits and advantages of the disclosed exemplary embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates one example of a radio network configuration;

FIG. 2 is a sequence diagram illustrating an exemplary operation of a radio network;

FIG. 3 is a block diagram illustrating a configuration example of a radio communication apparatus;

FIG. 4 illustrates one example of a frame;

FIG. 5 is a sequence diagram illustrating an exemplary operation of a radio network;

FIG. 6 is a flowchart illustrating an exemplary operation of the radio communication apparatus; and

FIG. 7 is a flowchart illustrating an exemplary operation of the radio communication apparatus

### DESCRIPTION OF EMBODIMENTS

Hereinafter, an embodiment of the present disclosure will be described in detail with reference to the accompanying drawings. Note that, the embodiment described below is one example and the present disclosure is not limited by the below-described embodiment.

For example, wireless mesh networks have the advantages of being infrastructure independent, scalable, communication energy efficient, and redundant and therefore robust. For example, PTL 1 discloses a technique related to control on transmission timings for mesh points for effectively utilizing redundancy of a wireless mesh network composed of a plurality of mesh points (for example, corresponding to nodes).

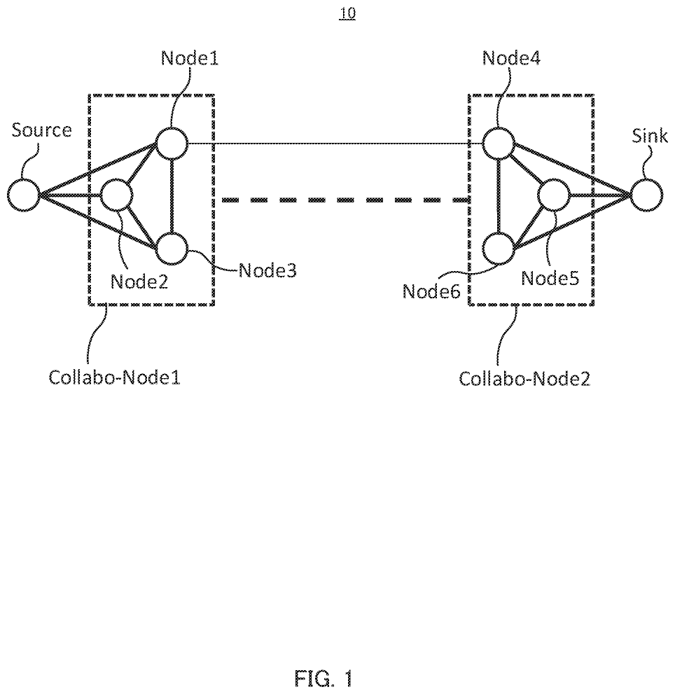

FIG. 1 is a diagram illustrating a configuration example of a radio network. Radio network 10 illustrated in FIG. 1 is, for example, a wireless mesh network including a source node (in other words, a transmitter node), nodes 1 to 6, and a sink node (in other words, a destination node).

For example, radio network 10 may be a system that autonomously performs communication based on the contents of a signal (e.g., a frame) received by each node. In other words, radio network 10 does not have to be a centralized system in which a particular node directs other nodes to control communications.

For example, in FIG. 1, nodes connected by lines indicate nodes capable of communicating with one another (in other words, nodes located at a distance where the nodes are capable of communicating with one another). In addition, the thicknesses of the lines in FIG. 1 indicate the communication quality between the nodes (e.g., Signal to Noise Ratio (SNR)).

In FIG. 1, the distance between the source node (first node) and each of nodes 1 to 3 is shorter as compared with the distance between node 1 (second node) and node 4, for example, and the source node and each of nodes 1 to 3 can communicate with each other in an environment with high communication quality. Likewise, in FIG. 1, the distance between the sink node and each of nodes 4 to 6 is shorter as compared with the distance between nodes 1 and 4, for example, and the sink node and each of nodes 4 to 6 can communicate with each other in an environment with high communication quality. In other words, in FIG. 1, nodes 1 and 4 are located at a distance where communication is possible, but the communication quality may be lower as compared with the distance and the communication quality between the source node and nodes 1 to 3 (or between the sink node and nodes 4 to 6) since the distances between nodes 1 and 4 is long.

Here, the higher the communication quality (e.g., SNR), the more stable the communication or the higher the communication speed can be. On the other hand, the lower the communication quality, the higher the Bit Error Rate (BER) of the radio communication, and the higher the probability of data lost. Therefore, the throughput may be reduced in the wireless mesh network, for example.

For example, the communication quality is likely to be low and the probability of data lost may be high in the communication between node 1 and node 4 in radio network 10 illustrated in FIG. 1, as compared with the communication between the other nodes. In this case, data retransmission is likely to occur in the communication between node 1 and node 4, which may reduce the throughput of radio network 10.

In the following, one example in which data retransmission occurs in communication between nodes (for example, between node 1 and node 4) will be described.

[Assumption]

For example, in radio network 10, it is assumed that each node holds the following information.

(a) Information about the next relay node (in other words, the next relay destination) for forwarding a data frame to the destination node (e.g., the source node or sink node). For example, in FIG. 1, the source node holds information indicating node 1 as the next relay destination, node 1 holds information indicating node 4 as the next relay destination, and node 4 holds information indicating the sink node as the next relay destination. In FIG. 1, the source node may perform relay to node 1 via another node, or node 4 may perform relay to the sink node via another node. For example, each node may determine the next relay destination by referring to a routing table that describes at least the next relay destination.

(b) Information about a node that each node is capable of communicating with, and the communication quality (e.g., Received Signal Strength Indicator (RSSI)) of communication between each node and another node that each node is capable of communicating with.

(c) Information about the time to synchronize between nodes (in other words, a timing, time step, or reference time)

### Packet Transmission Example

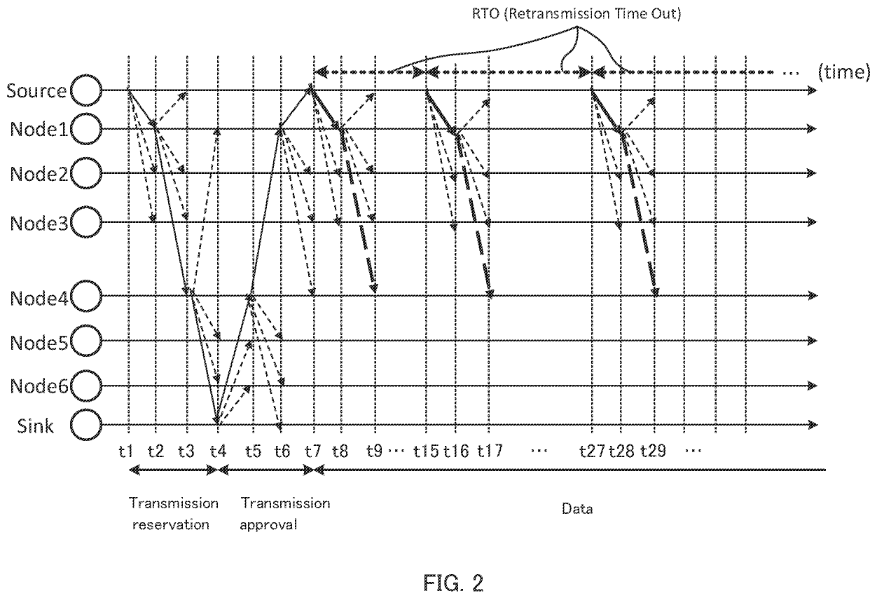

FIG. 2 is a sequence diagram illustrating an example of transmission of a radio signal (also referred to as a packet or a frame) in radio network 10 illustrated in FIG. 1. An exemplary operation at each time step (hereinafter referred to as “t”) on the horizontal axis illustrated in FIG. 2 will be described below.

At t1, for example, the source node transmits, to node 1, a transmission reservation frame (for example, also referred to as a transmission reservation signal) for performing data communication addressed to the sink node.

At t2, for example, node 1 and nodes 2 and 3 located around node 1 receive the transmission reservation frame from the source node. For example, node 1 may determine that the relay node of the signal (here, the transmission reservation frame) from the source node to the sink node is node 1, and may forward the transmission reservation frame to node 4. In other words, node 2 and node 3 may determine that the relay node of the signal (here, the transmission reservation frame) addressed to the sink node from the source node is node 1, and do not have to forward the transmission reservation frame (e.g., discard the transmission reservation frame). Thereafter, when the received signal is not addressed to the node having received the signal and the node is not a relay destination, the node does not have to forward the received signal (e.g., discards the received signal).

At t3, for example, node 4 receives the transmission reservation frame from node 1. Node 4 may then forward the transmission reservation frame to the sink node.

At t4, the sink node and node 1, node 5, and node 6 that can communicate with node 4 receive the transmission reservation frame. The sink node determines (in other words, recognizes) that the received transmission reservation frame is addressed to the sink node and may transmit, to node 4, a transmission approval frame (for example, also referred to as a transmission approval signal) addressed to the source node.

At t5, node 4 and nodes 5 and 6 located around node 4 receive the transmission approval frame from the sink node. For example, node 4 may determine that the relay node of the signal (here, the transmission approval frame) from the sink node to the source node is node 4, and may forward the transmission approval frame to node 1.

At t6, node 1 receives the transmission approval frame from node 4. Node 1 may then forward the transmission approval frame to the source node.

At t7, the source node and node 2, node 3, and node 4 capable of communicating with node 1 receive the transmission approval frame. The source node may determine that the received transmission approval frame is addressed to the source node and may transmit, to node 1, the data frame (e.g., also referred to as data or data signal) addressed to the sink node.

At t8, node 1 and nodes 2 and 3 capable of communicating with node 1 receive the data frame from the source node. For example, node 1 may determine that the relay node of the signal (here, the data frame) addressed to the sink node from the source node is node 1, and may forward the data frame to node 4.

At t9, for example, the source node, node 2, and node 3 capable of communicating with node 1 receive the data frame from node 1. On the other hand, for example, the data frame from node 1 is not received by node 4 (in other words, the data is lost). Here, the size of the data frame is likely to be larger than the size of another frame such as, for example, the transmission reservation frame or the transmission approval frame. Therefore, for example, as illustrated in FIG. 2, in the communication between node 1 and node 4 in which the communication quality is lower than the communication quality between the other nodes, the transmission and reception of the data frame may fail even when the transmission reservation frame or the transmission approval frame can be transmitted and received.

At t15, the source node does not receive a reception completion frame (e.g., also called reception completion signal), for example, even after the elapse of a defined value (e.g., called Retransmission Time Out (RTO)) of the period between the data frame transmission (e.g., t7) and reception of the reception completion frame with respect to the data frame. Accordingly, the source node may transmit, to node 1 (in other words, retransmit) the data frame addressed to the sink node.

At t16, node 1 and nodes 2 and 3 capable of communicating with node 1 receive the data frame. For example, node 1 may determine that the relay node of the signal from the source node to the sink node is node 1, and may forward the data frame to node 4. At t17, for example, like at t9, the source node, node 2, and node 3 capable of communicating with node 1 receive the data frame. On the other hand, like at t9, for example, the data frame from node 1 is not received by node 4 (in other words, the data frame is lost).

Subsequently, the source node may, for example, repeat retransmission of the data frame per RTO. For example, the length of the RTO may be configured longer (e.g., twice as long) each time data retransmission is performed.

Thus, in FIG. 2, the communication between node 1 and node 4 may fail and the retransmission of the data frame may be repeated. Accordingly, the communication of other nodes is interfered, for example. Thus, the throughput of radio network 10 is reduced.

In view of the above, one exemplary embodiment of the present disclosure is described in connection with one example of a method for improving throughput in radio network 10.

For example, in radio network 10 according to one exemplary embodiment of the present disclosure, nodes 1 to 3 that can communicate with the source node may collaboratively relay (e.g., concurrently transmit, collaboratively transmit, or cooperatively transmit) a radio signal (e.g., a data frame) addressed to the sink node. Likewise, for example, nodes 4 to 6 that can communicate with the sink node may collaboratively relay a radio signal (e.g., the reception completion frame) addressed to the source node. By collaborative relay by a plurality of nodes, it is possible to improve the reception power (in other words, the communication quality) at the nodes on the reception side, and to reduce retransmission of the radio signal, thereby improving the throughput of radio network 10.

In the following, a group including nodes that may perform collaborative relay is referred to as a “Collabo node (or relay group).” In FIG. 1, a group including node 1, node 2, and node 3 is referred to as “Collabo node 1,” and a group including node 4, node 5, and node 6 is referred to as “Collabo node 2.” At least two nodes in each of the Collabo nodes may collaboratively relay radio signals to another Collabo node. Note that, “Collabo” is an abbreviation for “Collaboration.”

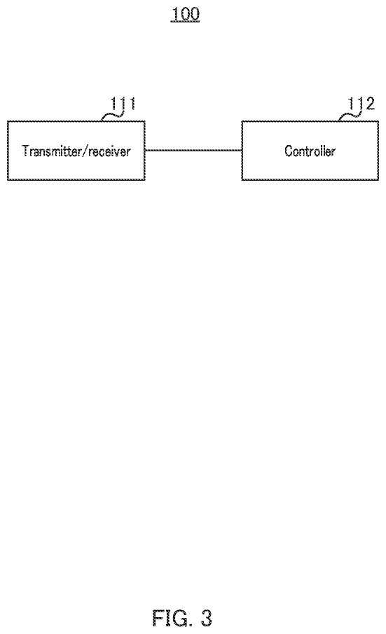

FIG. 3 is a block diagram illustrating a configuration example of a node (for example, corresponding to the radio communication apparatus) according to one exemplary embodiment of the present disclosure. Each of the source node, nodes 1 to 6, and the sink node illustrated in FIG. 2 may have, for example, the configuration of node 100 illustrated in FIG. 3.

Node 100 illustrated in FIG. 3 may include, for example, transmitter/receiver 111 and controller 112.

Transmitter/receiver 111 performs at least one of radio transmission and radio reception of a radio signal (e.g., the transmission reservation frame, the transmission approval frame, the data frame, or the reception completion frame described above) under the control of controller 112, for example.

For example, transmitter/receiver 111 may receive a radio signal addressed to node 100 or a radio signal addressed to another node. In addition, for example, transmitter/receiver 111 may transmit or forward (in other words, relay) a radio signal addressed to another node.

The radio communication system in transmitter/receiver 111 may be, for example, a radio Local Area Network (LAN), Bluetooth (registered trademark), LPWA, or a system using a millimeter wave band (for example, WiGig (registered trademark)), or may be another radio communication system.

Controller 112 controls, for example, transmission, reception, or forwarding of the radio signal.

For example, as described above, controller 112 may hold information on a next relay node to which the radio signal is forwarded, information on other nodes that can communicate with node 100, information on reception qualities (e.g., RSSIs) between the other nodes and node 100, or information on a synchronization time.

For example, when a radio signal is inputted, or when receiving a radio signal from another node, controller 112 may control the forwarding of the radio signal to the next relay node. For example, when receiving the radio signal (e.g., a data frame or a reception completion frame) from another node, controller 112 may determine, based on information on collaborative relay included in the radio signal, whether or not to relay (in other words, collaboratively relay) the radio signal, when node 100 is not a relay node (in other words, a relay device) of the radio signal.

Further, for example, based on the radio signal received from another node (e.g., the transmission reservation frame or transmission approval frame), controller 112 may include, in the radio signal, information about the collaborative relay. The information on the collaborative relay may include, for example, information on a relay node (hereinafter, referred to as a “bottleneck node (second node)”) of the relay nodes relaying the radio signal which performs relay in collaboration with another node, or information on a node (hereinafter, referred to as a “concurrent transmission node (third node)”) that performs transmission (collaborative relay) together with the relay nodes.

### Frame Configuration Example

An example of a frame configuration (or frame format) in radio network 10 described above will be described.

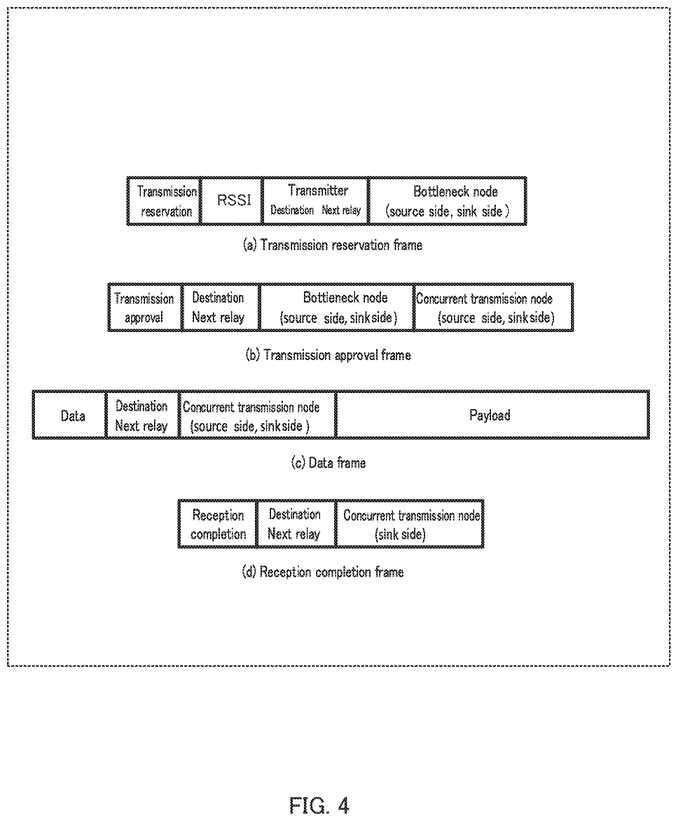

FIG. 4 is a diagram illustrating a configuration example of a frame.

In radio network 10, in data communication from the source node (first node) to the sink node, each node 100 may operate based on, for example, the following four types of frames when the source node transmits a “transmission reservation frame” to the sink node and the source node receives a “reception completion frame” for data from the sink node, for example, as illustrated in the frames illustrated in FIG. 4.

<(a) Transmission Reservation Frame>

The transmission reservation frame is, for example, a frame used to reserve data transmission from the source node to the sink node.

The transmission reservation frame illustrated in FIG. 4 may include, for example, a field indicating a frame type (e.g., “transmission reservation”), and a field indicating a transmitter node, a destination node, and a next relay node.

Further, the transmission reservation frame illustrated in FIG. 4 may include, for example, a field indicating a node (e.g., a bottleneck node) among relay nodes between the transmitter node and the destination node which can become unable to communicate. The bottleneck node may be, for example, a relay node at which the reception quality (e.g., RSSI) between this node and a communication partner (e.g., any of the nodes with which node 100 is capable of communicating) is less than a threshold. The field indicating the bottleneck node may indicate, for example, a bottleneck node on the source node side (for example, Collabo node 1 illustrated in FIG. 1) and a bottleneck node on the sink node side (for example, Collabo node 2 illustrated in FIG. 1).

Further, the transmission reservation frame illustrated in FIG. 4 may include, for example, a field indicating a RSSI (in other words, a threshold of RSSI) that is a criterion for determining the bottleneck node. In case that the criterion for determining the bottleneck node is a criterion other than RSSI, the criterion may be described in this field (RSSI field).

For example, when the relay node (for example, node 1 in FIG. 1) receiving the transmission reservation frame illustrated in FIG. 4 compares an RSSI measured when the relay node receives the transmission reservation frame with an RSSI described in the transmission reservation frame and determines that the relay node is the bottleneck node, the relay node may add information (for example, a node ID) identifying this relay node to the bottleneck node field of the transmission reservation frame, and transmit the transmission reservation frame to a next forwarding destination.

<(b) Transmission Approval Frame>

The transmission approval frame is, for example, a frame used by the sink node to approve data transmission reservation for the source node.

The transmission approval frame illustrated in FIG. 4 may include, for example, a field indicating a frame type (e.g., “transmission approval”) and a field indicating a destination node and a next relay node.

Further, the transmission approval frame illustrated in FIG. 4 may include, for example, a field indicating bottleneck nodes (for example, on the source node side and the sink node side). Information about the bottleneck nodes included in the transmission approval frame may be the same as the information about the bottleneck nodes included in the transmission reservation frame received by the sink node, for example.

The transmission approval frame illustrated in FIG. 4 may include, for example, a field indicating the bottleneck nodes and a node (e.g., a concurrent transmission node) which collaboratively relays (hereinafter, for convenience, concurrently transmits) a radio signal. For example, concurrent transmission nodes on the source node side (for example, node 2 and node 3 of Collabo node 1 illustrated in FIG. 1) and concurrent transmission nodes on the sink node side (for example, node 5 and node 6 of Collabo node 2 illustrated in FIG. 1) may be indicated in the field indicating the concurrent transmission nodes.

For example, when the relay node is the bottleneck node, the relay node (for example, node 1 of Collabo node 1 illustrated in FIG. 1) receiving the transmission approval frame illustrated in FIG. 4 may add, to the transmission approval frame, information (for example, the node IDs of node 2 and node 3 of Collabo node 1 illustrated in FIG. 1) for identifying the concurrent transmission nodes that are to perform collaborative relay with the relay node, and transmit the transmission approval frame to the next forwarding destination.

For example, when node 4 of Collabo node 2 illustrated in FIG. 1 is the bottleneck node as the relay node, node 4 adds, to the transmission approval frame, the node IDs of node 5 and node 6 of Collabo node 2 illustrated in FIG. 1 as the information for identifying the concurrent transmission nodes that perform collaborative relay with the relay node. Further, when node 1 of Collabo node 1 illustrated in FIG. 1 is the bottleneck node as the relay node, node 1 adds, to the transmission approval frame, the node IDs of node 2 and node 3 of Collabo node 1 illustrated in FIG. 1 as the information for identifying the concurrent transmission nodes that perform collaborative relay with the relay node.

<(c) Data Frame>

The data frame is, for example, a frame used for transmission of data from the source node to the sink node.

The data frame illustrated in FIG. 4 may include, for example, a field indicating a frame type (e.g., “data”), a field indicating a destination node and a next relay node, and a field indicating a payload (in other words, a data part).

Further, the data frame illustrated in FIG. 4 may include, for example, a field indicating concurrent transmission nodes (for example, on the source node side and the sink node side). The information on the concurrent transmission nodes included in the data frame may be the same as the information on the concurrent transmission nodes included in the transmission approval frame received by the source node, for example. In the field indicating the concurrent transmission nodes, the information on the sink node side may be omitted.

For example, node 100 receiving the data frame illustrated in FIG. 4 may forward the data frame when node 100 is a concurrent transmission node and even when node 100 is not a relay node. Thus, the data frame is concurrently transmitted by the relay node and the concurrent transmission node.

<(d) Reception Completion Frame>

The reception completion frame is, for example, a frame used to notify completion of data reception from the sink node to the source node.

The reception completion frame illustrated in FIG. 4 may include, for example, a field indicating a frame type (e.g., “reception completion”) and a field indicating a destination node and a next relay node.

Further, the reception completion frame illustrated in FIG. 4 may include, for example, a field indicating a concurrent transmission node (for example, the sink node side). The information on the concurrent transmission node included in the reception completion frame may be the same as the information on the concurrent transmission node on the sink node side included in the data frame received by the sink node, for example. Since the reception completion frame may include a copy of the information on the concurrent transmission node included in the data frame as it is, it may include both the information on the source node side and the information on the sink node side.

For example, node 100 receiving the reception completion frame illustrated in FIG. 4 may forward the reception completion frame when node 100 is a concurrent transmission node and even when node 100 is not a relay node. As a result, the reception completion frame is concurrently transmitted by the relay node and the concurrent transmission node.

In the frames illustrated in FIG. 4, the concurrent transmission node is referred to as first information, the destination and the next relay are referred to as second information, and the bottleneck node is referred to as third information.

In the frames illustrated in FIG. 4, the transmission approval frame, the data frame, and the reception completion frame including the concurrent transmission node are referred to as a first frame. In the frames illustrated in FIG. 4, the transmission approval frame including the bottleneck node and the concurrent transmission node is referred to as a second frame. Further, in the frames illustrated in FIG. 4, the data frame including the concurrent transmission node and the reception completion frame are referred to as a third frame.

The frame configuration example has been described above. Note that the frame configuration illustrated in FIG. 4 is one example, and the configuration of each frame is not limited to the example illustrated in FIG. 4.

Next, an exemplary operation of radio network 10 will be described.

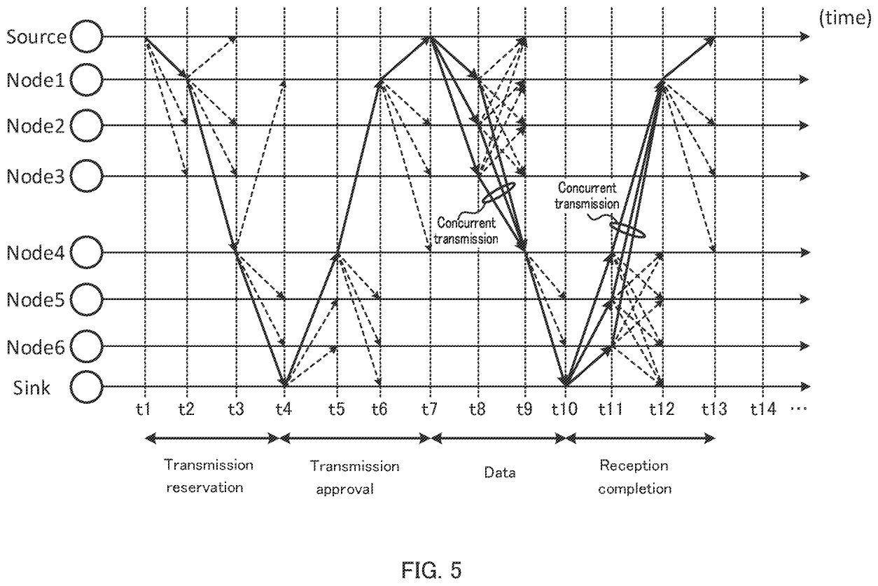

FIG. 5 is a sequence diagram illustrating an exemplary operation of radio network 10 (e.g., FIG. 1) according to one exemplary embodiment of the present disclosure. The exemplary operation at each time step (hereinafter referred to as “t”) on the horizontal axis illustrated in FIG. 5 will be described below.

At t1, for example, the source node may transmit the transmission reservation frame to node 1 for performing data communication addressed to the sink node. The transmission reservation frame may include, for example, information (in other words, a threshold) indicating a RSSI for judging a bottleneck node, a transmitter node (for example, an ID of the source node), a destination node (for example, an ID of the sink node), and a next relay node (for example, an ID of node 1). Note that the transmission reservation frame transmitted by the source node at t1 does not have to include the information about the bottleneck node, but when the source node transmits the transmission reservation frame and the bottleneck node is known, the source node may transmit the transmission reservation frame including the bottleneck node.

At t2, for example, node 1 and nodes 2 and 3 located around node 1 receive the transmission reservation frame from the source node. For example, node 1 may determine that the relay node for the signal from the source node to the sink node is node 1, and may forward the transmission reservation frame to node 4. For example, information indicating the next relay node (e.g., the ID of node 4) may be added to the transmission reservation frame transmitted by relay node 1 at t2.

At t3, for example, node 4 receives the transmission reservation frame from node 1. At this time, for example, it is assumed that the reception quality (e.g., RSSI) of the signal received from node 1 by node 4 is less than the threshold. In this case, in the transmission reservation frame, node 4 may add (in other words, additionally list or configure) node 1 as the bottleneck node on the source node side and add node 4 as the bottleneck node on the sink node side. Node 4 may then forward the transmission reservation frame to the sink node. In other words, node 4 may transmit, to a receiver node receiving the transmission reservation frame, the information indicating the bottleneck node that transmits the radio signal to a radio link in which communication quality is less than the threshold (hereinafter, also referred to as “bottleneck link”).

At t4, the sink node and node 1, node 5, and node 6 that can communicate with node 4 receive the transmission reservation frame. The sink node may determine that the received transmission reservation frame is addressed to the sink node. Then, for example, the sink node may copy, to the transmission approval frame, the bottleneck nodes (for example, the source node side: node 1 and the sink node side: node 4) included in the transmission reservation frame. Further, the sink node may configure the source node as the destination node and node 4 as the next relay node in the transmission approval frame. The sink node may then transmit the transmission approval frame to node 4.

At t5, node 4 and nodes 5 and 6 located around node 4 receive the transmission approval frame from the sink node. For example, node 4 may determine that the relay node of the signal from the sink node to the source node is node 4.

Node 4 may also determine that node 4 is the bottleneck node on the sink node side, in case that, for example, the transmission approval frame includes the information about the bottleneck node and the information about the bottleneck node indicates node 4. Then, node 4 configures, for example, a concurrent transmission node on the sink node side (in other words, a node that performs transmission together with node 4). For example, node 4 may determine, as the concurrent transmission node, a node at which the reception quality (e.g., RSSI) between this node and node 4 is greater than or equal to the threshold. In the example illustrated in FIG. 5, node 4 may determine node 5 and node 6 as the concurrent transmission nodes.

For example, in the transmission approval frame, node 4 may add (in other words, additionally list or configure) node 5 and node 6 as the concurrent transmission nodes on the sink node side. Further, node 4 may configure node 1 as the next relay node, for example.

Node 4 may then forward the transmission approval frame to node 1.

At t6, node 1 receives the transmission approval frame from node 4.

Also, in case that, for example, the transmission approval frame includes the information about the bottleneck node and the information about the bottleneck node indicates node 1, node 1 may determine that node 1 is the bottleneck node on the source node side. Then, node 1 may determine, for example, the concurrent transmission node on the source node side (in other words, a node that performs transmission together with node 1). For example, node 1 may determine, as the concurrent transmission node, a node at which the reception quality (e.g., RSSI) between this node and node 1 is greater than or equal to the threshold. In the example illustrated in FIG. 5, node 1 may determine node 2 and node 3 as the concurrent transmission nodes.

Node 1 may, for example, add nodes 2 and 3 as the concurrent transmission nodes on the source node side in the transmission approval frame.

Node 1 then forwards the transmission approval frame to the source node.

At t7, the source node and node 2, node 3, and node 4 capable of communicating with node 1 receive the transmission approval frame. The source node determines that the received transmission approval frame is addressed to the source node.

At t7, the source node may copy, for example, the concurrent transmission nodes (for example, the source node side: node 2 and node 3; the sink node side: node 5 and node 6) included in the transmission approval frame to the data frame. The source node configures the sink node as the destination node and configures node 1 as the next relay node in the data frame. The source node transmits the data frame to node 1.

As is understood from the above, in the transmission of the transmission reservation frame from the source node to the sink node, the bottleneck nodes in the transmission path between the source node and the sink node are identified. In the transmission of the transmission approval frame from the sink node to the source node, the concurrent transmission nodes for the bottleneck nodes are identified.

As described above, the source node, for example, generates the data frame including the information about the concurrent transmission nodes in addition to the information indicating the node that transmits the data frame to the bottleneck link (for example, the information indicating the relay node), and transmits the generated data frame to the nodes in Collabo node 1.

At t8, node 1 and nodes 2 and 3 capable of communicating with node 1 receive the data frame from the source node.

For example, node 1 determines that the relay node of the signal from the source node to the sink node is node 1. Node 1, for example, configures node 4 as the next relay node and forwards the data frame to node 4.

Node 2 and node 3 determine that the relay node relaying the data frame is node 4. Further, for example, when the information on the concurrent transmission node included in the received data frame indicates each of node 2 and node 3, node 2 and node 3 determine that node 2 and node 3 are the concurrent transmission nodes on the source node side. Then, node 2 and node 3, for example, configure node 4 as the next relay node that is the transmission destination of the data frame received from the source node (in other words, as the receiver node in the bottleneck link), and transmit the data frame received from the source node to node 4.

The data frame is concurrently transmitted by nodes 1, 2, and 3 by the transmission processing of each of nodes 1 to 3 at t8 illustrated in FIG. 5. With the concurrent transmission of data, the reception power or reception quality of the data frame (e.g., SNR) is improved at node 4. Thus, the possibility of successful reception of the data frame at node 4 increases. In other words, for example, while receiver node 4 fails to receive data in the case of transmission by a single node (for example, by node 1), the possibility of successful reception of the data by receiver node 4 increases in the case of concurrent transmission by a plurality of nodes (for example, nodes 1 to 3).

Note that, although in FIG. 5, nodes 2 and 3 perform transmission to node 4, nodes 2 and 3 may perform transmission to nodes 5 and 6, and nodes 5 and 6 may be configured to forward the received data frame to the sink node.

At t9, for example, node 4 receives the data frame from nodes 1 to 3. Node 4 then forwards the data frame to the sink node.

At t10, the sink node and nodes 5 and 6 capable of communicating with node 4 receive the data frame. The sink node determines that the received data frame is addressed to the sink node. Then, the sink node may copy, in the reception completion frame, the concurrent transmission nodes (for example, node 5 and node 6) on the sink node side included in the data frame, for example. Further, the sink node configures the source node as the destination node and configures node 4 as the next relay node in the reception completion frame. The sink node transmits the reception completion frame to node 4.

As described above, the sink node, for example, generates the reception completion frame including the information about the concurrent transmission nodes in addition to the information indicating the node that transmits the reception completion frame to the bottleneck link (for example, the information indicating the relay node), and transmits the generated reception completion frame to the nodes in Collabo node 2.

At t11, node 4 and nodes 5 and 6 capable of communicating with node 4 receive the reception completion frame from the sink node.

For example, node 4 determines that the relay node relaying the signal from the sink node to the source node is node 4. Node 4, for example, configures node 1 as the next relay node and forwards the reception completion frame to node 1.

Further, node 5 and node 6 determines that, for example, the relay node of the reception completion frame received is node 4. Further, for example, when the information on the concurrent transmission node included in the reception completion frame indicates node 5 and node 6, node 5 and node 6 determine that node 5 and node 6 are the concurrent transmission nodes on the sink node side. Then, node 5 and node 6, for example, configure node 1 as the next relay node that is the transmission destination of the reception completion frame received from the sink node (in other words, as the receiver node in the bottleneck link), and transmit the reception completion frame received from the sink node to node 1.

The reception completion frame is concurrently transmitted by nodes 4, 5, and 6 by the transmission processing of each of nodes 4 to 6 at t11 illustrated in FIG. 5. With the concurrent transmission of reception completion frame, the reception power or reception quality of the reception completion frame (e.g., SNR) is improved at node 1. Thus, the possibility of successful reception of the reception completion frame at node 1 increases. In other words, for example, while receiver node 1 fails to receive data in the case of transmission by a single node (for example, by node 4), the possibility of successful reception of the data by receiver node 1 increases in the case of concurrent transmission by a plurality of nodes (for example, nodes 4 to 6).

At t12, node 1 receives the reception completion frame. Node 1 determines that the relay node of the reception completion frame is node 1, and forwards the reception completion frame to the source node.

At t13, the source node and nodes 2 and 3 capable of communicating with node 1 receive the reception completion frame. The source node determines that the received reception completion frame is addressed to the source node, and ends the data transmission processing from the source node to the sink node.

Thus, in radio network 10, in a link where the communication quality (e.g., SNR) can be less than the threshold (e.g., called the bottleneck link), the occurrence of packet loss in the bottleneck link can be reduced by the concurrent transmission by the plurality of nodes 100, and the retransmission of data can be suppressed. Throughput in radio network 10 can be improved by suppressing data retransmission.

Further, based on the information about the concurrent transmission node included in the data frame or reception completion frame, each node 100 is capable of individually (in other words, autonomously) determining whether or not to relay (in other words, concurrently transmit) the data frame or reception completion frame to another node when node 100 is not the relay node of the data frame or reception completion frame.

[Exemplary Operation of Node]

Next, an exemplary operation of each node (e.g., node 100) in radio network 10 will be described.

In the following, an exemplary operation of the source node that triggers communication and an exemplary operation of another node (for example, the relay node or the destination node (sink node)) will be described separately.

<Exemplary Operation of Source Node>

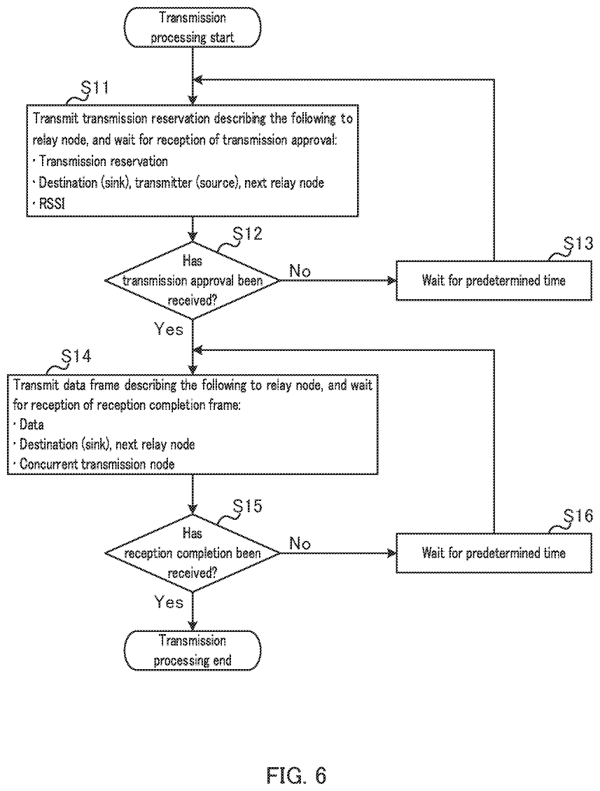

FIG. 6 is a flowchart illustrating an exemplary operation of the source node (for example, node 100).

In FIG. 6, the source node generates a transmission reservation frame, for example, and transmits the transmission reservation frame to the relay node (S11). The transmission reservation frame transmitted by the source node may include, for example, information about a destination node (e.g., sink node), a transmitter node (e.g., source node), a next relay node (e.g., information indicating a node ID), and information about an RSSI (e.g., threshold). In other words, in the transmission reservation frame transmitted by the source node, the field indicating the bottleneck node does not have to indicate any node.

After transmitting the transmission reservation frame, the source node enters a reception waiting state for a transmission approval frame.

The source node determines whether or not the transmission approval frame has been received (S12). In case that the transmission approval frame has not been received (S12: No), the source node may return to S11 after waiting for a predetermined period of time (S13) and retransmit the transmission reservation frame.

On the other hand, when receiving the transmission approval frame (S12: Yes), the source node generates a data frame and transmits it to the relay node (S14). The data frame transmitted by the source node may include, for example, the destination node (e.g., the sink node), information about the next relay node (e.g., information indicating a node ID), information about the concurrent transmission node, and data (payload). For example, the source node may copy the information about the “concurrent transmission node” described in the received transmission approval frame to the data frame.

After transmitting the data frame, the source node enters the reception waiting state for reception completion.

The source node determines whether or not it has received the reception completion frame (S15). When the reception completion frame has not been received (S15: No), the source node may wait for a predetermined time (e.g., RTO) (S16) and then return to the processing of S14 to retransmit the data frame. On the other hand, when receiving the reception completion frame (S15: Yes), the source node ends the transmission processing.

<Exemplary Operation of Relay Node and Sink Node>

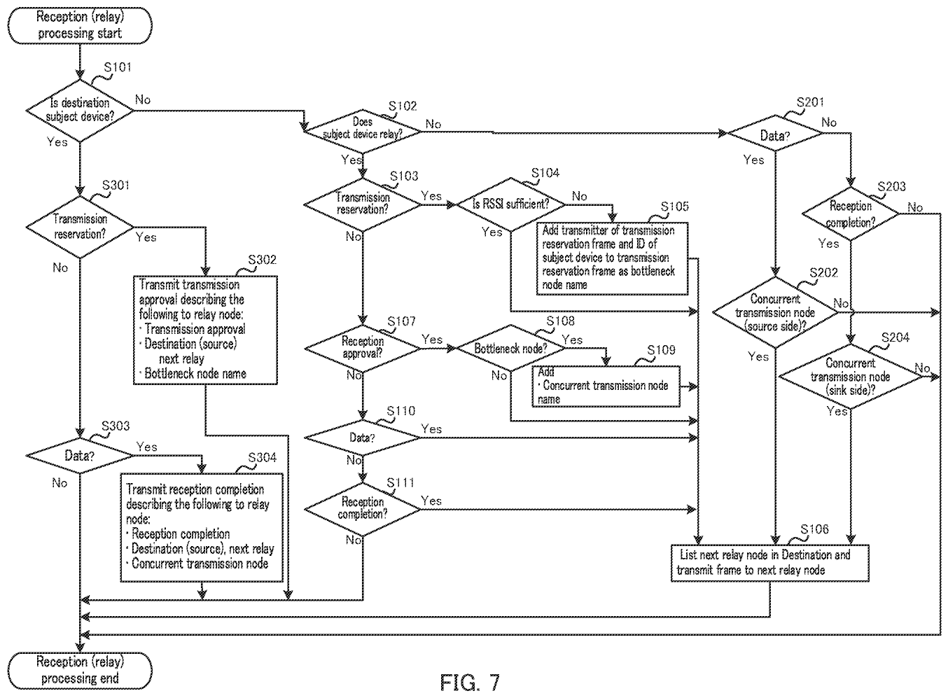

FIG. 7 is a flowchart illustrating an exemplary operation of the sink node, the relay node, or the concurrent transmission node (for example, node 100). Node 100 may start the processing illustrated in FIG. 7, for example, when receiving a radio signal (e.g., any of a transmission reservation frame, a transmission approval frame, a data frame, and a reception completion frame).

In FIG. 7, based on the received frame (e.g., information regarding a destination node), node 100 determines (S101) whether or not node 100 is the destination node (e.g., a sink node). When node 100 is the destination node (S101: Yes), node 100 performs processing (for example, S301 to S304 described later) related to the destination node (for example, the sink node).

[Processing Relevant to Relay Node]

In case that node 100 is not the destination node (S101: No), node 100 determines (S102) whether or not node 100 is the relay node based on, for example, the received frame (e.g., information on the relay node).

When node 100 is the relay node (S102: Yes), node 100 determines whether or not the received frame is the transmission reservation frame (S103).

In case that the frame is the transmission reservation frame (S103: Yes), node 100 determines, for example, whether or not the reception quality (e.g., RSSI) is equal to or greater than a threshold (S104). In other words, node 100 determines whether or not the RSSI is sufficiently high for data communication by node 100. When the RSSI is less than the threshold (S104: No), node 100 configures, as the bottleneck node on the source node side, the ID of the transmitter node transmitting the transmission reservation frame and configures the ID of node 100 as the bottleneck node on the sink node side, for example, in the transmission reservation frame (S105).

After the processing of S105 or when the RSSI is equal to or greater than the threshold (S104: Yes), node 100 configures the next relay node in the frame (here, the transmission reservation frame), and transmits the frame to the next relay node (S106).

In S103 illustrated in FIG. 7, when the frame is not the transmission reservation frame (S103: No), node 100 determines whether or not the received frame is the transmission approval frame (S107).

In case that the frame is the transmission approval frame (S107: Yes), node 100 determines (S108), based on, for example, information about the bottleneck node included in the received transmission approval frame, whether or not node 100 is the bottleneck node. In case that node 100 is the bottleneck node (S108: Yes), node 100 configures a concurrent transmission node (e.g., a node ID) in, for example, the transmission approval frame (S109). At this time, for example, node 100 may configure a relay destination for the concurrent transmission in the transmission approval frame.

For example, node 100 may determine (in other words, configure or select), as the concurrent transmission node, from among nodes capable of communicating with node 100, a node at which the RSSI between node 100 and the node is greater than or equal to the threshold. Node 100 may configure the concurrent transmission node on the source node side when node 100 is the bottleneck node on the source node side, and may configure the concurrent transmission node on the sink node side when node 100 is the bottleneck node on the sink node side.

After processing of S109 or when node 100 is not the bottleneck node (S108: No), node 100 configures the next relay node in the frame (here, the transmission approval frame) and transmits the frame to the next relay node (S106).

In S107, when the frame is not the transmission approval frame (S107: No), node 100 determines whether or not the received frame is the data frame (S110). When the frame is the data frame (S110: Yes), node 100 configures the next relay node in the frame (here, the data frame), and transmits the frame to the next relay node (S106).

On the other hand, when the frame is not the data frame (S110: No), node 100 determines whether or not the received frame is the reception completion frame (S111). When the frame is the reception completion frame (S111: Yes), node 100 configures the next relay node in the frame (here, the reception completion frame) and transmits the frame to the next relay node (S106).

[Processing Relevant to Concurrent Transmission Node]

In S102, when node 100 is not the relay node (S102: No), for example, node 100 determines whether or not the received frame is the data frame (S201).

When the received frame is the data frame (S201: Yes), node 100 determines whether or not node 100 is the concurrent transmission node on the source side (S202). In case that node 100 is the concurrent transmission node on the source side (S202: Yes), node 100 configures the next relay node in the frame (here, the data frame), and transmits the frame to the next relay node (S106). On the other hand, when node 100 is not the concurrent transmission node on the source side (S202: No), node 100 ends the processing illustrated in FIG. 7.

Further, in S201, when the frame received by node 100 is not the data frame (S201: No), node 100 determines whether or not, for example, the received frame is the reception completion frame (S203).

When the frame received by node 100 is the reception completion frame (S203: Yes), it is determined whether or not node 100 is the concurrent transmission node on the sink side (S204). In case that node 100 is the concurrent transmission node on the sink side (S204: Yes), node 100 configures the next relay node in the frame (here, reception completion frame), and transmits the frame to the next relay node (S106). On the other hand, when the frame is not the reception completion frame (S204: No), node 100 ends the processing illustrated in FIG. 7.

[Processing Relevant to Sink Node]

In S101, when node 100 is a destination node (for example, a sink node) (S101: Yes), node 100 determines whether or not the received frame is a transmission reservation frame (S301).

In case that the frame is the transmission reservation frame (S301: Yes), node 100 generates the transmission approval frame and transmits it to the relay node (S302). For example, when the transmission reservation frame includes bottleneck nodes (e.g., node IDs) on the source node side and the sink node side, node 100 may copy the bottleneck nodes to the transmission approval frame. Further, the transmission approval frame may include, for example, the destination node (e.g., the source node) and the next relay node. For example, after transmitting the transmission approval frame, node 100 enters the reception waiting state for the data frame from the source (in other words, ends the reception processing).

On the other hand, when the frame is not the transmission reservation frame (S301: No), node 100 determines whether or not the received frame is the data frame (S303).

In case that the frame is the data frame (S303: Yes), node 100 generates the reception completion frame and transmits it to the relay node (S304). For example, node 100 may copy, to the reception completion frame, the concurrent transmission node (e.g., node ID) on the sink node side included in the data frame. Further, the reception completion frame may include, for example, the destination node (e.g., the source node) and the next relay node. For example, when the frame is not the data frame (S303: No) or after the processing of S304, node 100 may end the reception processing.

The exemplary operation in radio network 10 has been described above.

In the present embodiment, in a radio signal (e.g., data frame or reception completion frame), when the information (e.g., information on the concurrent transmission node) indicating a node that performs transmission together with a node that transmits the radio signal to the radio link (e.g., bottleneck link) where communication quality is less than a threshold indicates node 100, node 100 configures a receiver node in the bottleneck link as the destination of the received radio signal. Then, node 100 transmits (in other words, collaboratively transmits) the radio signal to the receiver node.

Collaborative relay (e.g., concurrent transmission) by a plurality of nodes can improve reception quality in, for example, a link in which the reception quality is less than a threshold (in other words, the bottleneck link where data loss is highly likely), and can reduce retransmission of a radio signal (e.g., a data frame), thereby improving throughput in radio network 10.

Further, each of the plurality of nodes 100 in radio network 10 individually controls the concurrent transmission based on the information included in a frame to be forwarded. Therefore, according to the present embodiment, each node 100 autonomously performs concurrent transmission control in radio network 10. It is thus possible to suppress an increase in complexity in radio network 10.

As described above, according to the present embodiment, throughput in a wireless mesh network can be improved.

The exemplary embodiments of the present disclosure have been described above.

Note that, an RSSI threshold included in the transmission reservation frame may be determined based on at least one of, for example, the size of transmission data, location information of nodes, moving directions of the nodes, orientations of the nodes, hardware information of the nodes (e.g., antenna configurations and the like), and the like.

In the above embodiment, the RSSI is used as the criterion for the bottleneck node (in other words, for the bottleneck link), but the criterion for the bottleneck node is not limited to the RSSI and may be other data. For example, the bottleneck node may be determined based on at least one of location information of nodes, directions of movement of the nodes, orientations of the nodes, communication history, hardware information of the nodes (e.g., antenna configurations and the like), or the like.

In addition, the above-described embodiment has been described, for example, in connection with the case where the concurrent transmission node is a node at which the RSSI between nodes is equal to or greater than a threshold. This threshold may vary, for example, depending on the RSSI between the bottleneck node on the source node and the bottleneck node on the sink node. For example, the lower the RSSI between the bottleneck node on the source node side and the bottleneck node on the sink node side, the lower the threshold of RSSI for judgement of the concurrent transmission node. With this threshold configuration, for example, the lower the RSSI between the bottleneck node on the source node side and the bottleneck node on the sink node side, the more likely the concurrent transmission node for the bottleneck node is to be configured. Thus, the reception quality by concurrent transmission can be improved.

Further, the number of nodes configured as the concurrent transmission node may be determined based on, for example, the communication quality (e.g., RSSI) at a relay node that is the bottleneck node. For example, the lower the communication quality of the relay node, the more the nodes may be configured as the concurrent transmission node. By determining the number of concurrent transmission nodes, a node receiving a frame can receive the frame without excessive or insufficient reception quality in concurrent transmission.

Further, in the present embodiment, node 100 may, for example, repeatedly transmit/receive frames in the bottleneck link, and may determine, based on multiple times of frame transmission and reception, which concurrent transmission nodes are to participate in transmission in the bottleneck link. In this case, for example, after receiving the data frame, the bottleneck node on the sink node side may transmit, to the bottleneck node on the source node side, information on an addition request for addition of a concurrent transmission node. Alternatively, before transmitting the reception completion frame, the sink node may transmit, to the source node, a frame including information on the addition request for addition of the concurrent transmission node, and each node corresponding to the transmission path of the frame may control the concurrent transmission operation based on the frame for addition request for the concurrent transmission node.

Further, the above-described embodiment has been described in connection with a case in which the RSSI is applied as the criterion for the concurrent transmission node, but the criterion for the concurrent transmission node is not limited to the RSSI, and other information may be used. For example, the concurrent transmission node may be determined based on at least one of location information of nodes, moving directions of the nodes, orientations of the nodes, a communication history, hardware information of the nodes (e.g., antenna configurations and the like), or the like.

The configuration of radio network 10 described with respect to the above embodiment is one example, and is not limited. For example, at least one of the number of nodes in radio network 10, the number of Collabo nodes (in other words, groups), the number of nodes in each of the Collabo nodes, and the communication environment between the nodes (in other words, the connection relationship) may be different from that in the example illustrated in FIG. 1.

In the above-described embodiment, for example, the information on the bottleneck node and the information on the concurrent transmission node are not limited to those in the case where the information is included in the frames illustrated in FIG. 4, and may be included in another frame.

Each node involved in the communication may also store and divert the information on the bottleneck link or concurrent transmission node. For example, each node may utilize information on the bottleneck link or concurrent transmission node in communications where a plurality of large data frames succeed one another, or in a different communication performed after time has elapsed.

The reception quality is not limited to the RSSI. For example, information about the quality of the received signal such as an SNR, Signal to Interference and Noise Ratio (SINR), or bit error rate (or packet error rate) may also be used.

In the above embodiment, the concurrent transmission by a plurality of nodes has been described, but the transmission processing by a plurality of nodes is not limited to the concurrent transmission, and beamforming by a single node or a plurality of nodes may be applied, for example.

Further, after a node involved in the transmission of the data frame determines that it is involved in the transmission of the data frame, the node may wait for reception of the frame so as not to perform transmission for communication of another node. For example, a node that relays the transmission reservation frame may wait to receive a frame after relaying the transmission reservation frame. The concurrent transmission node may receive the transmission approval frame, confirm that the concurrent transmission node is added as the concurrent transmission node in the transmission approval frame, and then enter the data waiting state for concurrent transmission.

By way of example, the above-described embodiment has been described in connection with the case where concurrent transmission is applied to the data frame and the reception completion frame as illustrated in FIG. 5, but frames to which concurrent transmission is applied are not limited to the data frame and the reception completion frame. For example, concurrent transmission may be applied to at least one of the transmission reservation frame, the transmission approval frame, the data frame, and the reception completion frame. For example, by applying concurrent transmission to such frames as data frames having a larger frame size than other frames, packet retransmission can be suppressed and throughput can be improved. Further, for example, by applying the concurrent transmission to such a frame as the reception completion frame having a higher importance than other frames, the possibility of transmitting and receiving the frame (in other words, the reliability of the link) can be increased.

Various embodiments have been described with reference to the drawings hereinabove. Obviously, the present disclosure is not limited to these examples. Obviously, a person skilled in the art would arrive variations and modification examples within a scope described in claims, and it is understood that these variations and modifications are within the technical scope of the present disclosure. Each constituent element of the above-mentioned embodiments may be combined optionally without departing from the spirit of the disclosure.

The above embodiments have been described with an example of a configuration using hardware, but the present disclosure can be realized by software in cooperation with hardware.

In addition, the functional blocks used for describing each of the above-described embodiments may typically be implemented as a Large Scale Integration (LSI) that is an integrated circuit. The integrated circuit controls each functional block used in the description of the above embodiments and may include an input and an output. The LSI may be individually formed as chips, or one chip may be formed so as to include a part or all of the functional blocks. While the designation of “LSI” is used herein, the LSI may be referred to as an Integrated Circuit (IC), Small Scale Integration (SSI), Middle Scale Integration (MSI), a system LSI, a super LSI, Very Large Scale Integration (VLSI), or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used.

In case that future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof. The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

In the above descriptions, the expression “section” used for the components may be replaced with another expression such as “circuit (circuitry),” “assembly,” “device,” “unit,” or “module.”

### Summary of Embodiments

A radio communication apparatus according to one exemplary embodiment of the present disclosure is a radio communication apparatus including: reception circuitry, which, in operation, receives a first frame transmitted by a first node in a wireless mesh network; and control circuitry, which, in operation, configures a relay destination node as second information in case that the first frame includes first information indicating a third node that performs transmission in cooperation with a second node that transmits a radio signal to a radio link in which communication quality is less than a threshold in the wireless mesh network and in case that the third node included in the first information indicates the radio communication apparatus, the relay destination node being a node to which the second node transmits the first frame, the second information indicating a relay destination node to which the third node transmits the first frame.

In one exemplary embodiment of the present disclosure, the first frame is transmission approval, a data signal, or a signal indicating completion of reception of the data signal.

A radio communication apparatus according to one exemplary embodiment of the present disclosure is a radio communication apparatus including: reception circuitry, which, in operation, receives a second frame in a wireless mesh network; control circuitry, which, in operation, configures first information in the second frame in case that the second frame includes third information indicating a second node that transmits a radio signal to a radio link in which communication quality is less than a threshold in the wireless mesh network and in case that the third information indicates the radio communication apparatus, the first information indicating a third node that performs transmission in cooperation with the radio communication apparatus; and transmission circuitry, which, in operation, transmits the second frame to a relay destination node.

In one exemplary embodiment of the present disclosure, the second frame is a signal indicating transmission approval.

A radio communication apparatus according to one exemplary embodiment of the present disclosure includes: control circuitry, which, in operation, generates a third frame including third information and first information, the third information indicating a second node that transmits a radio signal to a radio link in which communication quality is less than a threshold in a wireless mesh network, the first information indicating a third node that performs transmission in cooperation with a first node; and transmission circuitry, which, in operation, transmits the third frame to the second node and the third node.

In one exemplary embodiment of the present disclosure, the third frame is transmission approval.

In a radio communication method according to one exemplary embodiment of the present disclosure, a radio communication apparatus receives a first frame transmitted by a first node in a wireless mesh network, and configures relay destination node as second information in case that the first frame includes first information indicating a third node that performs transmission in cooperation with a second node that transmits a radio signal to a radio link in which communication quality is less than a threshold in the wireless mesh network and in case that the third node included in the first information indicates the radio communication apparatus, the relay destination node being a node to which the second node transmits the first frame, the second information indicating a relay destination node to which the third node transmits the first frame.

A radio communication system according to one exemplary embodiment of the present disclosure includes: a first node that transmits a first frame in a wireless mesh network; a second node that transmits the first frame to a radio link in which communication quality is less than a threshold, the first frame being transmitted by the first node; and a third node, in which the third node receives the first frame transmitted by the first node, and the third node configures a relay destination node as second information in case that the first frame received from the first node includes first information indicating a node that performs transmission in cooperation with the second node and in case that the first information indicates the third node, the relay destination node being a node to which the second node transmits the first frame, the second information indicating a relay destination node to which the third node transmits the first frame.

The disclosure of Japanese Patent Application No. 2020-020579, filed on Feb. 10, 2020, including the specification, drawings and abstract is incorporated herein by reference in its entirety.

### INDUSTRIAL APPLICABILITY

The present disclosure is applicable to radio communication systems.

### REFERENCE SIGNS LIST

10 Radio network
100 Node
111 Transmitter/receiver
112 Controller

1. A radio communication apparatus, comprising:
reception circuitry, which, in operation, receives a first frame transmitted by a first node in a wireless mesh network; and
control circuitry, which, in operation, configures a relay destination node as second information in case that the first frame includes first information indicating a third node that performs transmission in cooperation with a second node that transmits a radio signal to a radio link in which communication quality is less than a threshold in the wireless mesh network and in case that the third node included in the first information indicates the radio communication apparatus, the relay destination node being a node to which the second node transmits the first frame, the second information indicating a relay destination node to which the third node transmits the first frame.

2. The radio communication apparatus according to claim 1, wherein
the first frame is transmission approval, a data signal, or a signal indicating completion of reception of the data signal.

3. A radio communication apparatus, comprising:
reception circuitry, which, in operation, receives a second frame in a wireless mesh network;
control circuitry, which, in operation, configures first information in the second frame in case that the second frame includes third information indicating a second node that transmits a radio signal to a radio link in which communication quality is less than a threshold in the wireless mesh network and in case that the third information indicates the radio communication apparatus, the first information indicating a third node that performs transmission in cooperation with the radio communication apparatus; and
transmission circuitry, which, in operation, transmits the second frame to a relay destination node.

4. The radio communication apparatus according to claim 3, wherein
the second frame is a signal indicating transmission approval.

5. A radio communication apparatus, comprising:
control circuitry, which, in operation, generates a third frame including third information and first information, the third information indicating a second node that transmits a radio signal to a radio link in which communication quality is less than a threshold in a wireless mesh network, the first information indicating a third node that performs transmission in cooperation with a first node; and
transmission circuitry, which, in operation, transmits the third frame to the second node and the third node.

6. The radio communication apparatus according to claim 5, wherein
the third frame is transmission approval.

7. A radio communication method, comprising steps performed by a radio communication apparatus of:
receiving a first frame transmitted by a first node in a wireless mesh network; and
configuring a relay destination node as second information in case that the first frame includes first information indicating a third node that performs transmission in cooperation with a second node that transmits a radio signal to a radio link in which communication quality is less than a threshold in the wireless mesh network and in case that the third node included in the first information indicates the radio communication apparatus, the relay destination node being a node to which the second node transmits the first frame, the second information indicating a relay destination node to which the third node transmits the first frame.

8. A radio communication system, comprising:
a first node that transmits a first frame in a wireless mesh network;
a second node that transmits the first frame to a radio link in which communication quality is less than a threshold, the first frame being transmitted by the first node; and
a third node, wherein
the third node receives the first frame transmitted by the first node, and
the third node configures a relay destination node as second information in case that the first frame received from the first node includes first information indicating a node that performs transmission in cooperation with the second node and in case that the first information indicates the third node, the relay destination node being a node to which the second node transmits the first frame, the second information indicating a relay destination node to which the third node transmits the first frame.
